(19) United States
(12) Patent Application Publication
(10) Pub. No.: US 2015/0147734 A1
(43) Pub. Date: May 28, 2015

(54) MOVEMENT ASSESSOR

(71) Applicant: International Business Machines Corporation, Armonk, NY (US)

(72) Inventors: Christina I. Flores, Keller, TX (US); Romelia H. Flores, Keller, TX (US)

(73) Assignee: International Business Machines Corporation, Armonk, NY (US)

(21) Appl. No.: 14/088,951

(22) Filed: Nov. 25, 2013

(51) Int. Cl. G09B 19/00

(52) U.S. Cl. CPC G09B 19/003
USPC 434/247

(57) ABSTRACT

A movement activity is assessed in a movement assessment environment. A processor receives user movement data, captured by a sensor, of a user in the movement assessment environment. The processor receives a match request from the user, wherein the match request includes a request for an instructor that matches the user. The processor compares the user movement data of the user to a plurality of other movement data, wherein the plurality of other movement data includes at least one instructor movement data and at least one professional movement data. The processor determines, responsive to the comparing, a match between the user and an instructor, wherein the match is determined based at least in part on a similarity between the user movement data and at least one of the plurality of other movement data.

### BACKGROUND

The present invention relates generally to movement assessment, and more particularly to using sensory movement assessments in a movement assessment environment.

Movement can be defined as a change of place or position or posture. Some basic examples of human movement may encompass common, “simple” movements such as crawling, walking, and running. The process of learning these movements, for individuals, may be driven by natural inclinations or by sensory analysis, e.g., learning by seeing. More complex movements, such as those in ballet, must be learned primarily through sensory analysis.

Complex movements that do not occur naturally must be learned primarily through sensory analysis. As individuals see others move, they imitate these movements until they gain satisfactory results. There is a certain necessity of sensory learning within a variety of activities involving movement. Although the initial stimulus for learning proper movement involves sensory input, the vital information necessary to perfect such movement involves unbiased opinions.

Current movement-capture technology exists that measure basic movements of individuals (e.g., movement sensors or controllers for videogame consoles, etc.), but this form of movement-capture technology can be lacking in measurements of very precise and specific movements which are necessary for the purpose of evaluation and assessment of the quality of the movements.

In many forms of movement activities the learning process generally requires a student-instructor relationship, in which students learn various techniques and styles of a specific movement activity from their instructors, and subsequently advance through receiving feedback given by the instructor. When seeking an instructor, a student's goal is to achieve improvement in technique and style of a specific activity. Typically, within a student-instructor environment, the instructors will give students feedback utilizing their own personal knowledge of proper technique and training methods, which have been refined and altered to reflect the style of the instructor through time and experience. Yet there is no one way to perform a specific movement, because there are many different forms, styles, and teaching methods which may all allow for the practice or further understanding of proper movement technique.

This results in various difficulties within a student-instructor environment. For example, no single instructor will be capable of obtaining full knowledge and understanding of all possible postures, styles, and techniques within a specific movement activity. For this reason, instructors of a specific movement activity may have differences in opinion on how to practice or accomplish a single technique. These differences in opinion are based on at least two factors: personal experience and personal preference. Personal experience involves the techniques an instructor has gained knowledge and experience in, and the various means by which these techniques were taught to them. Personal preference involves the instructor's opinion of a specific technique, or learning method, and whether or not the instructor found these techniques and methods beneficial to themselves.

These differences in instructional opinion lead to a second difficulty found in a student-instructor environment, which is that, with their limited knowledge of techniques and methods, the style and technique preferences of instructors may differ greatly from those of their students. The problem for the students then becomes finding for themselves instructors who have similar preferences in styling, while showing proficiency in, and understanding of improvement methods and techniques within the areas in which each student requires assistance.

Several known techniques involving motion analytics for addressing these issues include those described by Brian Mac Sports Coach (see http://www.brianmac.co.uk/index.htm), by the Laban Movement Study (see http://www.limsonline.org/), and by the Motion Analysis Corporation (see http://www.motionanalysis.com). Generally, these known techniques involve movement analytics for the purpose of gaining information regarding the subject's movement, for gaining information on the movement of an individual, for the description, documentation, and visualization of movement analysis, for the display to individuals of movement data for their own interpretation, and for the return of data for a qualified individual (i.e., a scientist) to interpret.

### SUMMARY

Embodiments of the present invention provide for a program product, system, and method to assess a movement activity in a movement assessment environment. A processor receives user movement data, captured by a sensor, of a user in the movement assessment environment. The processor receives a match request from the user, wherein the match request includes a request for an instructor that matches the user. The processor compares the user movement data of the user to a plurality of other movement data, wherein the plurality of other movement data includes at least one instructor movement data and at least one professional movement data. The processor determines, responsive to the comparing, a match between the user and an instructor, wherein the match is determined based at least in part on a similarity between the user movement data and at least one of the plurality of other movement data.

### BRIEF DESCRIPTION OF THE SEVERAL VIEWS OF THE DRAWINGS

FIG. 1 is a functional block diagram of a movement assessment environment, including a movement assessor, in accordance with an embodiment of the present invention.

FIG. 2 shows a flowchart depicting steps followed during movement assessment in accordance with an embodiment of the present invention.

FIG. 3 shows a flowchart depicting steps followed during movement assessment in accordance with an embodiment of the present invention.

FIG. 4 is a functional block diagram of a computer system in accordance with an embodiment of the present invention.

### DETAILED DESCRIPTION

According to the techniques introduced herein, movement is assessed through analysis of digital or analog information (e.g., input taken from sensors, camera, or other media device, etc.), which is recorded or measured using an apparatus. The recorded information details a user's movement with the precision required in order to be processed and assessed using algorithms for the purpose of providing users an unbiased assessment of their skill level, strengths, and weaknesses within a particular movement activity. Examples of the types of movement measurements the apparatus can provide include, but are not limited to: general body location, direction, directional orientation, posture, pose, spinning velocity and acceleration, directional velocity and acceleration; individual limb locations, limb movement directions, velocities and accelerations (e.g., including a user's digits on hands and feet, and even the movement of the user's hair, etc.); and the location, velocity, acceleration of user's attire and any additional objects being utilized (e.g., such as props, hats, etc.).

Capturing this detailed movement according to the techniques introduced herein provides information useful for properly assessing movement via a movement assessor system, described in detail below in the context of the Figures. This assessment can be used in various ways to enhance a user's performance by providing feedback such as: an unbiased evaluation for the purpose of self-improvement or reflection; listing for the user instructors and professionals who have similar stature and styling as the user, but have strength in the areas where the user may be weak; and connections to students of similar caliber who are currently taking lessons from a suggested instructor.

The techniques introduced herein provide: an ability to evaluate movement technique through intelligent analysis, in order to provide feedback to the user in the form of a movement assessor analysis; student-instructor pairing suggestions which take into consideration both a side-by-side evaluation between the movement assessment of instructors and the movement assessment of students (e.g., in order to assess the similarity in stature, technique, and styling, etc.), as well as student preferences (e.g., preferred instructor gender, teaching style, cost per lesson, etc.), to suggest optimal instructors for a given student based on personal need including, but not limited to: similarity in movement style between instructor and student; personal goals of a student within the movement activity (e.g., to become a professional, or just to enjoy a hobby, etc.); skill level analysis of both instructor and student (e.g., finding an instructor who is skilled in technique where the student needs improvement, etc.); instructor personality (e.g., friendly, disciplined, results-driven, etc.); instructor locale and availability (e.g., distance from home, hours of operation, online availability/lessons, etc.); instructor cost, reputation, and reviews.

The techniques introduced herein also provide: ability to specify whether an individual is a student, an instructor, or a professional (or any combination thereof), and providing connectivity between all users within a social media setting; the ability for instructors to easily view and assess their students' previous instructor(s) for the purpose of evaluating student skill level and previously learned (e.g., potentially undesirable, etc.) technique; the ability for students to easily preview the movement of their instructor through social media, even before a preliminary lesson; a metric which allows for unbiased assessment of a user's skill level, strengths and weaknesses, individual progression, and instructor effectiveness; the ability for an instructor to view an unbiased assessment (e.g., through the movement assessor system, etc.) of a student's skill level, strengths, and weaknesses, in order to design personalized lesson plans for the student, even prior to the first lesson; ability for a user to find other instructors of similar technique and style in the event that an instructor is quitting or otherwise unavailable, so that the user may efficiently find a suitable replacement or stand-in instructor.

Accordingly, utilizing the techniques introduced herein a student therefore may benefit greatly from unbiased assistance in determining his or her areas of weakness and finding an appropriate instructor, among other things, utilizing a movement assessor system, which informs the user of their movement technique strengths, weaknesses, and skills. This in turn can not only inform the user of their personal skill level analysis, but can also be used to pair students with their optimal instructor, based on the student's specific skill level and needs.

The techniques introduced herein also include performing comparison assessments based on pre-populated information for professionals and instructors, and include improvement assessments, giving users information on personal progress, and instruction effectiveness. The techniques introduced herein are applicable to any type of movement activity such as sports, dance types, meditation exercises, etc. In addition, the techniques introduced herein can be tied with social business aspects which enable connection of a user with other students, instructors, or professionals, and can involve providing recommended listings of instructors to take lessons from, professionals to observe in nearby venues, as well as on-line training available from remote instructors.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

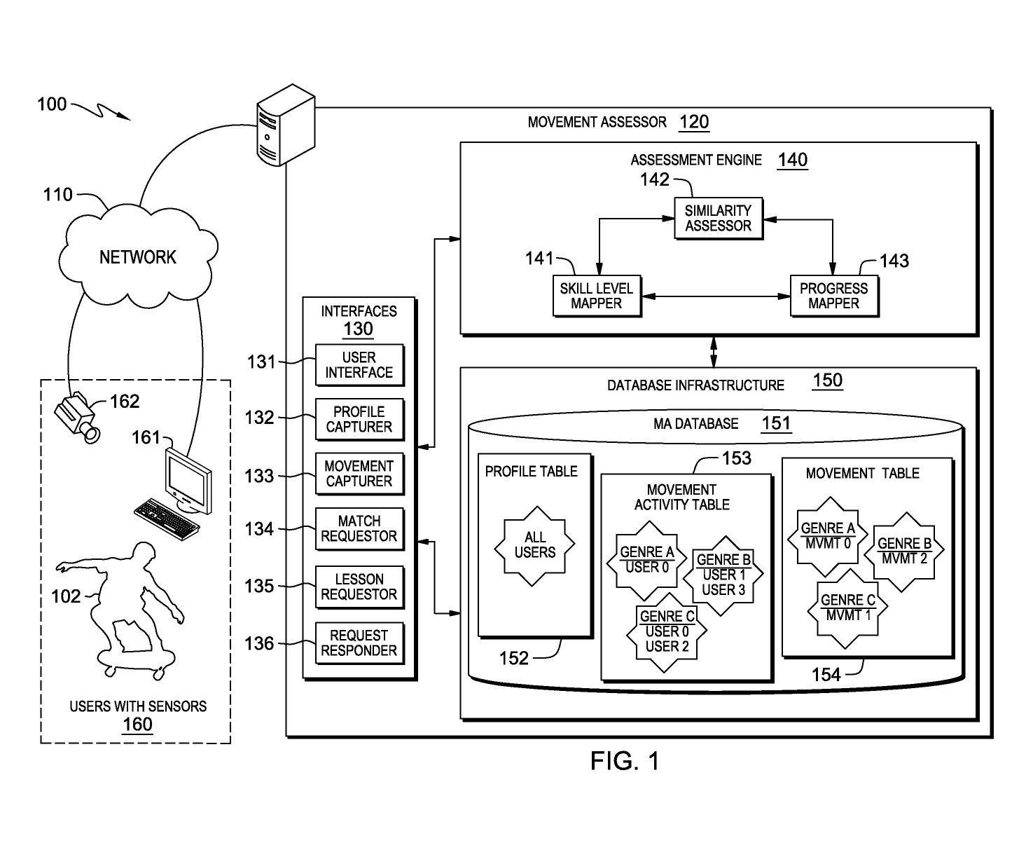

Referring now to FIG. 1, a functional block diagram of movement assessment environment 100, including movement assessor 120, in accordance with an embodiment of the present invention is shown. Movement assessment environment 100 includes network 110 and movement assessor 120, as well as user computer 161 and sensor 162 shown in the sub-environment users with sensors 160. User 102, also shown in the sub-environment users with sensors 160, can be an individual interested in or involved in any movement activity, such as ballet, baseball, yoga, swimming, astronaut training (e.g., in a weightless environment or simulated weightless environment, etc.), medical training for surgeries (e.g., requiring very precise, delicate, and slow movements, in contrast to a fast dance, etc.), CPR training, race car driving, or any other genre of movement activity. A group of such users may be students, instructors, professionals, or any combination thereof within these activities. Students are users seeking instruction, instructors are users seeking to give instruction and who have a deep level of understanding of a movement activity, and professionals are users with extensive experience within a movement activity. Users may be interested in a variety of movement activities, and may have different classifications for each one. For instance, a given user may be a professional ballet dancer and ballet dance instructor, a yoga instructor, and a baseball student. As discussed in detail below, user 102 can interact with computer 161, sensor 162, and movement assessor 120 to receive unbiased assistance in determining his or her areas of weakness, to find an appropriate instructor, and to perform other tasks according to the techniques introduced herein. Further, movement assessor 120 can inform user 102 of his or her movement technique strengths, weaknesses, and skills, can inform user 102 of a personal skill level analysis, and can also be used to pair user 102 (e.g., in the role of a student, etc.) with an optimal instructor, based on skill level and needs.

Network 110 can be, for example, a local area network (LAN), a wide area network (WAN) such as the Internet, or a combination of the two, and can include wired or wireless connections. In general, network 110 can be any combination of connections and protocols that will support communications via various channels between movement assessor 120, user computer 161, and sensor 162 in accordance with an embodiment of the invention.

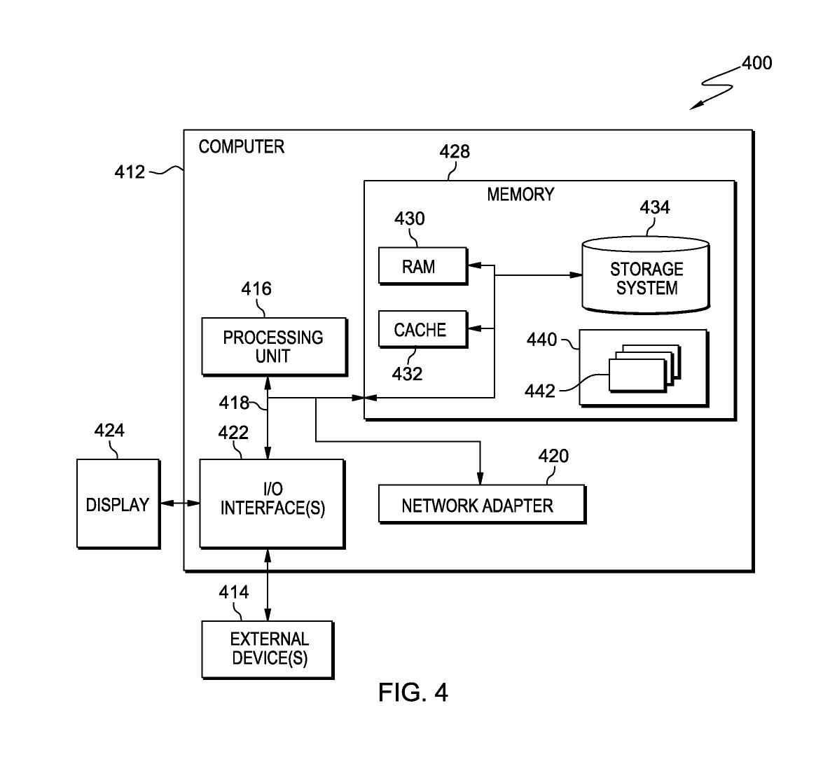

In various embodiments, each of movement assessor 120 and user computer 161 can include a laptop, tablet, or netbook personal computer (PC), a desktop computer, a personal digital assistant (PDA), a smart phone, a mainframe computer, or a networked server computer. Further still, movement assessor 120 can include computing systems utilizing clustered computers and components to act as single pools of seamless resources when accessed through network 110, or can represent one or more cloud computing datacenters. In general, each of movement assessor 120 and user computer 161 can be any programmable electronic device as described in further detail with respect to FIG. 4.

In various embodiments, sensor 162 can be a standalone network-accessible sensor or can be a sensor directly connected to one or more of movement assessor 120 and user computer 161. Sensor 162 can include one or more of a variety of sensors for detecting movement or position according to different techniques, including, for example, a passive optical sensor (e.g., a visible spectrum or infrared camera, etc.), an active optical sensor (e.g., LIDAR, etc.), an acoustic sensor (e.g., ultrasonic rangefinder, etc.), or another sensor.

User computer 161 includes software, such as a web browser program, for interacting with movement assessor 120 via network 110. For example, movement assessor 120 can host a web page, that includes one or more of the items in interfaces 130, viewable on the web browser program of user computer 161. The web browser program of user computer 161 can load the web page from movement assessor 120, to enable user 102 to interact with interfaces 130, as discussed in detail below.

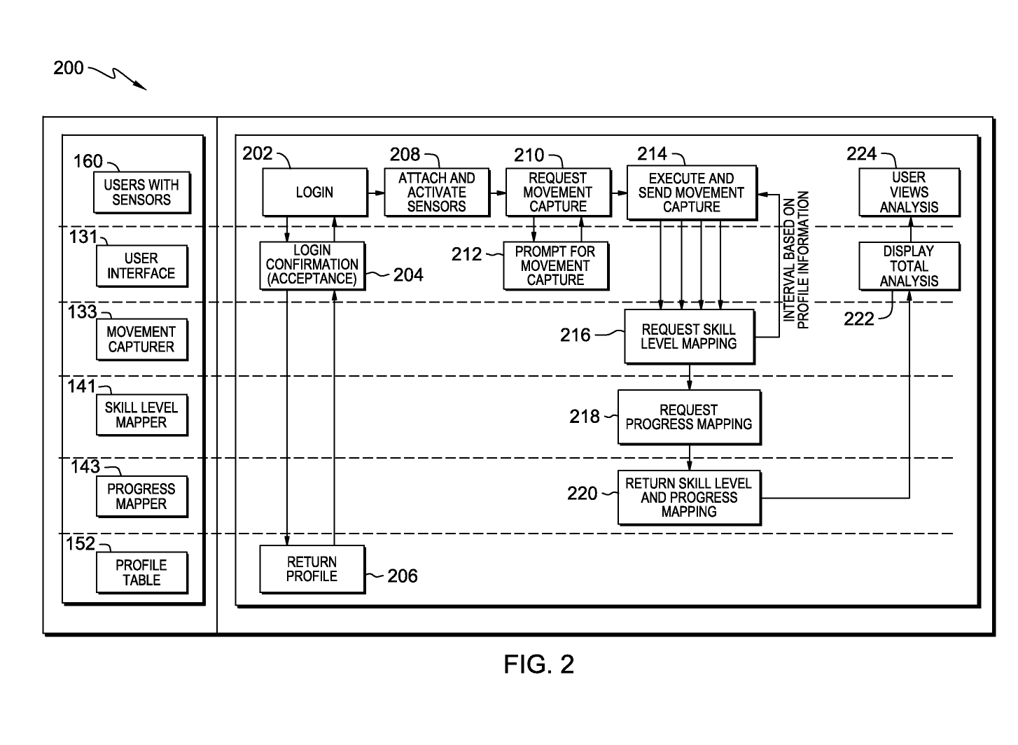

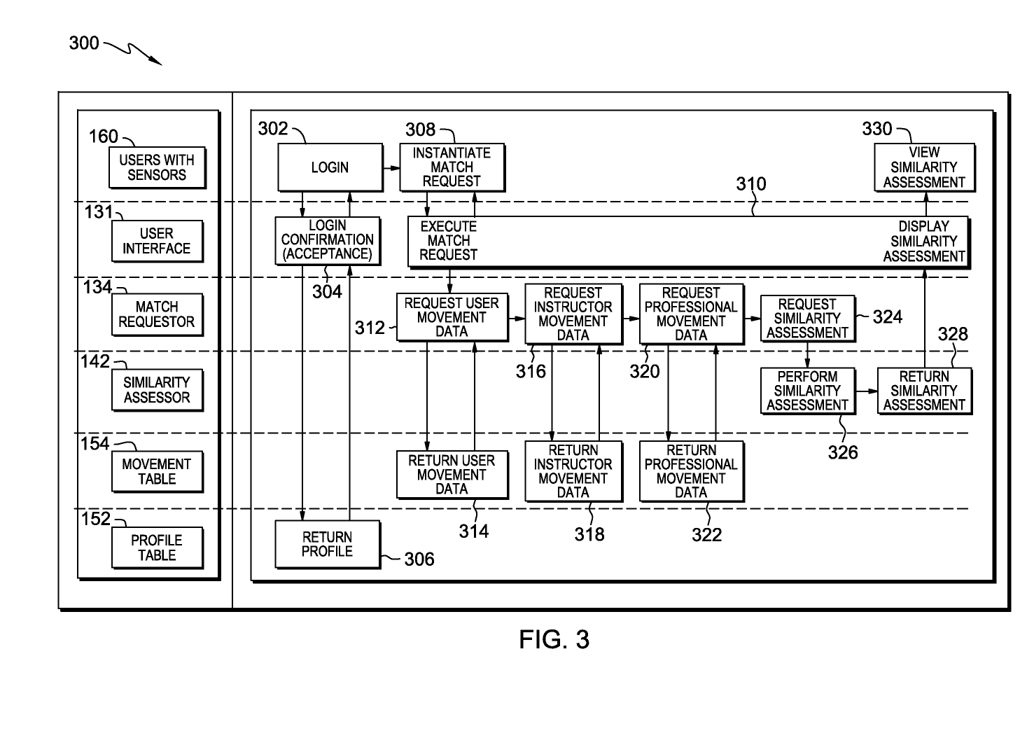

Generally, movement assessor 120 can gain a wide variety of information in the form of movement captures before deployment for operational use. This is accomplished by having professionals and instructors execute appropriate movement captures for movement assessor 120 to analyze. This allows movement assessor 120 to gain information on the composition of proper movement technique, and variations in movement styling, to be used in a variety of use cases. For example, in a first use case discussed in more detail below in the context of FIG. 2, user 102 utilizes movement assessor 120 to receive analysis on his or her overall movement skill level, strengths and weaknesses, and progress for personal reflection. In a second use case discussed in more detail below in the context of FIG. 3, user 102 instantiates a match request in order to find instructors and professionals with experience in teaching students of similar stature, size, posture, and movement technique. In a third use case, a student and an instructor agree upon lesson specifics, such as times, cost, location, etc. In a fourth use case, an instructor requests to view a student's motion assessment analysis for information on the student's skill level, once a lesson association has been agreed upon.

Movement assessor 120 includes interfaces 130, assessment engine 140, and database infrastructure 150. Interfaces 130 includes user interface 131, profile capturer 132, movement capturer 133, match requestor 134, lesson requestor 135, and request responder 136. Assessment engine 140 includes skill level mapper 141, similarity assessor 142, and progress mapper 143. Database infrastructure 150 includes MA (i.e., Movement Assessor) database 151, which itself includes profile table 152, movement activity table 153, and movement table 154. Interfaces 130, assessment engine 140, and database infrastructure 150, and their components interoperate as discussed in detail below.

Within interfaces 130, user interface 131 enables user 102 to access movement assessor 120 via network 110. User interface 131 can be available on all browsers, so that any user may access his or her data from his or her own computer, mobile device, etc. In one embodiment, the use of movement assessor 120 assumes proper equipment, such as sensors (e.g., sensor 162, etc.) and a device with Internet and networking capabilities in order to transfer data to the system.

Further within interfaces 130, profile capturer 132 enables user 102 to set up a unique profile, which contains his or her personal information (e.g., name, age, gender, etc.) as well as information utilized by movement assessor 120 such as personal strengths and weaknesses. Within this system, users are capable of creating a list of movement activities in which they participate and, for each activity, state whether they are a student, an instructor, a professional, or any combination thereof. Within a single movement activity, a user may deem him- or herself as being more than one specific type of user (e.g., student, instructor, professional, etc.). For example, user 102 may be both a student and an instructor.

Students may be required to input the minimum number of requirements (e.g., name, age, etc.) when setting up their profile. Instructors may be required to place their resume or credentials in their profile, so that this information may be utilized by the system, and can be seen by students before requesting lessons. Instructors may also specify general statures and styling of students they teach. Instructors may be encouraged to list the price range for their lessons, as well as available times, group class times, and class locations, for example. Professionals may be encouraged to place a listing of their accolades, accomplishments, and upcoming venue availability in their profiles. The data captured for the professionals can be utilized in enhancing the intelligence of movement assessor 120. As such, only users who reach a certain standard will be able to deem themselves as being, e.g., one or both of professionals and instructors in movement assessor 120, thereby allowing movement assessor 120 to use their movements and associated information as part of the standard by which others are assessed. Professionals who are not also instructors may appear on match requests (as discussed below), but may not receive lesson requests (in one embodiment, this enables self study). Professionals can use the system to gain visibility by being brought up on match requests. This enables professionals to post information about events, performances, etc. that they are involved in.

Further within interfaces 130, movement capturer 133 buffers and stores captured sensor data (e.g., data from sensor 162, etc.) from all users (e.g., from user 102, etc.), and creates movement capture instances. Movement capturer 133 sends this captured sensor movement data to be evaluated by movement assessor 120.

Further within interfaces 130, match requestor 134 allows a user to have his or her movement capture intelligently evaluated by movement assessor 120, in order to give a listing of instructors and professionals with similar styling and technique who are strong in areas where the user may be needing instruction. All users may obtain a movement analysis and request a list of optimal matches between themselves and the instructors and professionals, as discussed in detail below.

Further within interfaces 130, lesson requestor 135 enables students to obtain detailed information about a specific instructor's class schedule, fees, availability, etc., and to sign up for classes. In one embodiment, this capability is offered only to students. Lesson requestor 135 can also be leveraged to inform instructors of students' interest in their lessons and the students' information (in one embodiment, preferentially shared by the student based on his/her profile).

Further within interfaces 130, request responder 136 allows an instructor to accept or decline lesson requests. In one embodiment, this capability is offered only to instructors.

The various components of assessment engine 140 perform detailed movement analytics. Assessment engine 140 takes into account in its various analysis personal user specification found within a user's profile, such as a user's personal strengths and weaknesses, injuries or disabilities, and prior experience. Using the information gained from analyzing professional movement, assessment engine 140 provides user 102 with a variety of movement analysis by skill level mapper 141, similarity assessor 142, and progress mapper 143.

Within assessment engine 140, skill level mapper 141 compares data capture information within a specific movement activity for an individual user against data capture information from instructors and professionals with a similar stature and movement style. Skill level mapper 141 identifies the user's strengths and weaknesses in various movement techniques and postures and in which areas the user needs most improvement. Information from the user's profile can be taken into account such as disabilities, prior experience, etc. With this additional information, skill level mapper 141 can interpret movement in a different manner. For example, skill level mapper 141 may have a different assessment for a user who is inflexible (e.g., due to surgery, etc.), than that of a user who is flexible. Skill level mapper 141 can also vary its analysis based on a student's goals. For example, skill level mapper 141 may give a different analysis to a user who is seeking to be a professional than that of a user who is performing an activity for fun. Skill level mapper 141 can also analyze whether or not a user has the capability of becoming a professional within the specific movement activity, or whether a user's personal goals (e.g., from profile information, etc.) are within reach of their capabilities. Skill level mapper 141 can also inform the user of techniques that they are performing wrong, or in a way which may be potentially dangerous to the user (e.g., a movement technique being performed in such a way that the user is at risk of pulling a muscle, etc.). Skill level mapper 141 can also determine which movement techniques are not capable of being achieved, which techniques a user has the potential to master, and where the user's efforts are best spent.

Further within assessment engine 140, progress mapper 143 contrasts a user's current skill level analysis alongside a previous skill level analysis, to track the user's progress. Results returned include a progress analysis, as well as analysis of individual techniques and postures. In this way, a user may gain information on how he or she is progressing overall, or how much he or she have improved on a particular technique. For a student, this may also allow analysis of student-instructor efficiency, to determine whether a student's progress with an instructor is effective, slow, or stagnant.

Further within assessment engine 140, similarity assessor 142 can be utilized in obtaining a list of instructors and professionals of similar posture and technique as a user, upon a match request being made (e.g., via match requestor 134, etc.). Similarity assessor 142 can return a match list of all instructors and professionals evaluated as having similar stature, styling, etc., to the user. Before assessment, similarity assessor 142 can, using the user profile, as well as all instructor and professional profiles, eliminate from the match list instructors and professionals who differ greatly from the user (e.g., have sums or differences of profile characteristics that differ by more than a preset threshold, etc.). For example, if the user is short in stature, similarity assessor 142 will eliminate instructors and professionals who are tall in stature, if matching for the particular activity requires similar statures. Similarity assessor 142 differs from skill level mapper 141 in that it does not assess the skill level of the user against all instructors and professionals, but rather searches for subtle similarities between the user's personal styling (not overall skill) and that of instructors and professionals. Similarity assessor 142 also takes into account a user's profile specifications, such as the user's personal strengths and weaknesses (e.g., strength, flexibility, athleticism, etc.), preference in instructor (e.g., friendly, strict, driven, etc.), lesson preferences (e.g., location, cost, times, etc.), disabilities (e.g., injuries, etc.), or personal goals (e.g., to be a professional, or to just have fun, etc.). Similarity assessor 142 can take all the movement capture information and profile information into account, and return a match list with profile links to the instructors and professionals most similar to the user. The purpose of this matching includes informing the user of persons of similar style to learn from, either by enlisting in lessons, or by viewing profile media (e.g., videos, pictures, etc.) of the instructors and professionals. If the user is a student, they may send instructors on the match list a lesson request (e.g., by lesson requestor 135, etc.).

Database infrastructure 150 is where data is stored in movement assessor 120, including profile data, listing of all movement activities, and all movement data, for example.

Within database infrastructure 150, profile table 152 stores profile information for all users. Profile information can include generic user information, such as age, gender, and height, as well as information required by classification (e.g., student, instructor, professional, or any combination thereof, etc.). Within a specific activity, a student can be a user seeking instruction, an instructor can be a user seeking to give instruction and who has prior experience, and a professional can be a user with in depth experience and accolades. Profile information also includes user preferences relating to security, preferences regarding movement capturer 133 (e.g., frequency of data being sent by sensor 162, sensitivity of sensor 162, etc.), preferences on instructor (i.e., if the user is a student), the user's strengths and weaknesses, etc. Profile table 152 can also be used to associate the profiles of students and instructors who have agreed to a lesson request. This association can contain specifics regarding the lesson, such as agreed upon meeting times, cost per lesson, lesson plans, etc.

Further within database infrastructure 150, movement activity table 153 contains information for each movement activity, listing all users who place themselves as being participants (e.g., students, instructors, professionals, or any combination, etc.) within that specified activity. This is utilized for the classification of users, to keep track of which genres of movement activity a user is participating in, and in whether a user classifies him- or herself as being a student, instructor, professional, or any combination thereof.

Further within database infrastructure 150, movement table 154 contains movement capture information for each specific movement activity, holding all movement capture data submitted by a user through movement capturer 133. The data is associated to the movement activity to which it belongs and to the user who submitted the data. Users may participate in more than one movement activity, and may have more than one kind of movement capture. Data is stored for use by progress mapper 143 and allows for users to view their previous movement captures as references. Professional data can be used to keep movement assessor 120 current on professional movement, continually adding to the intelligence of movement assessor 120. In this way, movement assessor 120 will gain information on upcoming movement techniques, so that movement assessor 120 is always current and gaining intelligence. This will serve to enhance the overall intelligence of movement assessor 120.

Referring now to FIG. 2, flowchart 200 depicting steps followed during movement assessment in accordance with an embodiment of the present invention is shown. In step 202 user 102, in users with sensors 160 at user computer 161, logs in to movement assessor 120 via user interface 131. In step 204, user interface 131 requests profile information from profile table 152, and in step 206, profile information is retrieved from profile table 152. In step 208, sensor 162 is activated in users with sensors 160. In step 210, user 102 requests a movement capture in users with sensors 160, and in step 212 user interface 131 prompts user 102 for a movement capture. In step 214, user 102 executes a movement capture (i.e., by performing a motion activity for sensor 162), and data is sent to movement capturer 133 from sensor 162 at a time interval specified in the user profile. In step 216, movement capturer 133 requests a skill level mapping analysis, and movement assessor 120 returns a current skill level analysis (including, e.g., user strengths, weaknesses, and suggestions, etc.). In step 218, skill level mapper 141 requests a progress mapping analysis, and in step 220 progress mapper 143 returns an analysis comparing the current skill level analysis to a prior skill level and skill level analysis. In step 222, user interface 131 displays the skill level analysis, and in step 224 user 102 views the analysis in users with sensors 160.

Referring now to FIG. 3, flowchart 300 depicting steps followed during movement assessment in accordance with an embodiment of the present invention is shown. In step 302 user 102, in users with sensors 160 at user computer 161, logs in to movement assessor 120 via user interface 131. In step 304, user interface 131 requests profile information from profile table 152, and in step 306, profile information is retrieved from profile table 152. The profile information can contain user preferences (e.g., match preferences relating to instructors such as instructor location, technique strengths, height, stature, pricing, etc.). In step 308, user 102 instantiates a match request, and in step 310 user interface 131 executes the match request (step 308 is held open for later conclusion after step 328, below). To execute the match request, in step 312 match requestor 134 requests user movement data from movement table 154, and in step 314 movement table 154 returns the user movement data. In step 316 match requestor 134 requests instructor movement data from movement table 154, and in step 318 movement table 154 returns the instructor movement data. In step 320 match requestor 134 requests professional movement data from movement table 154, and in step 322 movement table 154 returns the professional movement data. In step 324 match requestor 134 requests a similarity analysis, and in step 326 similarity assessor 142 performs a similarity analysis with the user movement data, along with movement data for instructors and professionals. This assessment can also take into account user preferences. In step 328 similarity assessor 142 returns the similarity analysis, concluding step 310. In step 330 user 102 views the analysis in users with sensors 160.

Referring now to FIG. 4, a functional block diagram of a computer system in accordance with an embodiment of the present invention is shown. Computer system 400 is only one example of a suitable computer system and is not intended to suggest any limitation as to the scope of use or functionality of embodiments of the invention described herein. Regardless, computer system 400 is capable of being implemented and/or performing any of the functionality set forth hereinabove.

In computer system 400 there is computer 412, which is operational with numerous other general purpose or special purpose computing system environments or configurations. Examples of well-known computing systems, environments, and/or configurations that may be suitable for use with computer 412 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Each one of user computer 161 and movement assessor 120 can include or can be implemented as an instance of computer 412.

Computer 412 may be described in the general context of computer system executable instructions, such as program modules, being executed by a computer system. Generally, program modules may include routines, programs, objects, components, logic, data structures, and so on that perform particular tasks or implement particular abstract data types. Computer 412 may be practiced in distributed cloud computing environments where tasks are performed by remote processing devices that are linked through a communications network. In a distributed cloud computing environment, program modules may be located in both local and remote computer system storage media including memory storage devices.

As further shown in FIG. 4, computer 412 in computer system 400 is shown in the form of a general-purpose computing device. The components of computer 412 may include, but are not limited to, one or more processors or processing units 416, memory 428, and bus 418 that couples various system components including memory 428 to processing unit 416.

Bus 418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 412 typically includes a variety of computer system readable media. Such media may be any available media that is accessible by computer 412, and includes both volatile and non-volatile media, and removable and non-removable media.

Memory 428 can include computer system readable media in the form of volatile memory, such as random access memory (RAM) 430 and/or cache 432. Computer 412 may further include other removable/non-removable, volatile/non-volatile computer system storage media. By way of example only, storage system 434 can be provided for reading from and writing to a non-removable, non-volatile magnetic media (not shown and typically called a “hard drive”), upon which MA database 151 can be stored. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 418 by one or more data media interfaces. As will be further depicted and described below, memory 428 may include at least one program product having a set (e.g., at least one) of program modules that are configured to carry out the functions of embodiments of the invention.

Program 440, having one or more program modules 442, may be stored in memory 428 by way of example, and not limitation, as well as an operating system, one or more application programs, other program modules, and program data. Each of the operating system, one or more application programs, other program modules, and program data or some combination thereof, may include an implementation of a networking environment. Program modules 442 generally carry out the functions and/or methodologies of embodiments of the invention as described herein. Each one of user interface 131, profile capturer 132, movement capturer 133, match requestor 134, lesson requestor 135, request responder 136, skill level mapper 141, similarity assessor 142, and progress mapper 143 can be implemented as or can be an instance of program 440.

Computer 412 may also communicate with one or more external devices 414 such as a keyboard, a pointing device, etc., as well as display 424; one or more devices that enable a user to interact with computer 412 such as sensor 162; and/or any devices (e.g., network card, modem, etc.) that enable computer 412 to communicate with one or more other computing devices. Such communication can occur via Input/Output (I/O) interfaces 422. Still yet, computer 412 can communicate with one or more networks such as a local area network (LAN), a general wide area network (WAN), and/or a public network (e.g., the Internet) via network adapter 420. As depicted, network adapter 420 communicates with the other components of computer 412 via bus 418. It should be understood that although not shown, other hardware and/or software components could be used in conjunction with computer 412. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for movement assessment, the method comprising:
receiving, by a processor, user movement data, captured by a sensor, of a user in a movement assessment environment;
receiving, by the processor, a match request from the user, wherein the match request includes a request for an instructor that matches the user;
comparing, by the processor, the user movement data of the user to a plurality of other movement data, wherein the plurality of other movement data includes at least one instructor movement data and at least one professional movement data; and
responsive to the comparing, determining, by the processor, a match between the user and an instructor, wherein the match is determined based at least in part on a similarity between the user movement data and at least one of the plurality of other movement data.

2. The method of claim 1, wherein the user movement data includes a body location, a body orientation, a body stature, a body posture, and a body pose.

3. The method of claim 1, wherein the user movement data includes a body spinning velocity, a body spinning acceleration, a body directional velocity, and a body directional acceleration.

4. The method of claim 1, wherein the user movement data includes a limb location, a limb movement direction, a limb velocity, and a limb acceleration.

5. The method of claim 1, wherein the user movement data includes an attire location, an attire velocity, and an attire acceleration.

6. The method of claim 1, wherein determining the match between the user and the instructor includes determining that the instructor has a body stature that differs from the body stature of the user by less than a threshold.

7. The method of claim 1, wherein determining the match between the user and the instructor includes determining that the instructor has a skill in a field in which the user has less skill than the instructor.

8. The method of claim 1, wherein determining the match between the user and the instructor includes determining that the instructor has a personality that matches a preference of the user.

9. The method of claim 1, wherein determining the match between the user and the instructor includes determining that the instructor has a distance from the user that is less than a threshold.

10. The method of claim 1, further comprising transmitting, by the processor, a profile link of the instructor to the user.

11. A computer program product for movement assessment, the computer program product comprising:
one or more computer-readable tangible storage devices and program instructions stored on at least one of the one or more storage devices, the program instructions comprising:
program instructions to receive user movement data, captured by a sensor, of a user in a movement assessment environment;
program instructions to receive a match request from the user, wherein the match request includes a request for an instructor that matches the user;
program instructions to compare the user movement data of the user to a plurality of other movement data, wherein the plurality of other movement data includes at least one instructor movement data and at least one professional movement data; and
program instructions to determine, responsive to the comparison, a match between the user and an instructor, wherein the match is determined based at least in part on a similarity between the user movement data and at least one of the plurality of other movement data.

12. The computer program product of claim 11, wherein the user movement data includes a body location, a body orientation, a body stature, a body posture, and a body pose.

13. The computer program product of claim 11, wherein the user movement data includes a body spinning velocity, a body spinning acceleration, a body directional velocity, and a body directional acceleration.

14. The computer program product of claim 11, wherein the user movement data includes a limb location, a limb movement direction, a limb velocity, and a limb acceleration.

15. The computer program product of claim 11, wherein the user movement data includes an attire location, an attire velocity, and an attire acceleration.

16. The computer program product of claim 11, wherein determining the match between the user and the instructor includes determining that the instructor has a body stature that differs from the body stature of the user by less than a threshold.

17. The computer program product of claim 11, wherein determining the match between the user and the instructor includes determining that the instructor has a skill in a field in which the user has less skill than the instructor.

18. The computer program product of claim 11, wherein determining the match between the user and the instructor includes determining that the instructor has a personality that matches a preference of the user.

19. The computer program product of claim 11, wherein determining the match between the user and the instructor includes determining that the instructor has a distance from the user that is less than a threshold.

20. A system for movement assessment, the system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to receive user movement data, captured by a sensor, of a user in a movement assessment environment;
program instructions to receive a match request from the user, wherein the match request includes a request for an instructor that matches the user;
program instructions to compare the user movement data of the user to a plurality of other movement data, wherein the plurality of other movement data includes at least one instructor movement data and at least one professional movement data; and
program instructions to determine, responsive to the comparison, a match between the user and an instructor, wherein the match is determined based at least in part on a similarity between the user movement data and at least one of the plurality of other movement data.
